(19) United States
(12) Patent Application Publication
(10) Pub. No.: US 2018/0043614 A1
(43) Pub. Date: Feb. 15, 2018

(54) ADDITIVE MANUFACTURING APPARATUS AND METHODS

(71) Applicant: RENISHAW PLC, Wotton-under-Edge, Gloucestershire (GB)

(72) Inventors: Benjamin John GREENFIELD, Nantwich (GB); Jonathan MUNDAY, Stafford (GB); Christopher SUTCLIFFE, Liverpool (GB)

(73) Assignee: RENISHAW PLC, Wotton-under-Edge, Gloucestershire (GB)

(21) Appl. No.: 15/538,547

(22) PCT Filed: Dec. 23, 2015
(86) PCT No.: PCT/GB2015/054151

§ 371 Date: Jun. 21, 2017

(30) Foreign Application Priority Data
Dec. 23, 2014 (GB) 1423025.4

(51) Int. Cl. B29C 64/153; B29C 64/205; B22F 3/105

(52) U.S. Cl. CPC B29C 64/153; B22F 3/1055; B29C 64/205; B33Y 30/00

(57) ABSTRACT

An additive manufacturing apparatus builds a part by selectively consolidating flowable material in a layer-by-layer building process. The apparatus has an inert gas vessel having a build chamber a layering device for depositing layers of material in the build chamber; a scanner for delivering an energy beam to selected areas of each layer to consolidate flowable material of the layer, a gas flow circuit for generating an inert gas flow through the build chamber and a cooling device arranged to cool an internal surface of the gas flow circuit to generate cooled inert gas. The gas flow circuit is arranged such that the cooled inert gas can be delivered into the build chamber.

### FIELD OF INVENTION

This invention concerns additive manufacturing apparatus and methods in which layers of material are consolidated in a layer-by-layer manner to form a part. The invention has particular, but not exclusive application, to selective laser solidification apparatus, such as selective laser melting (SLM) and selective laser sintering (SLS) apparatus.

### BACKGROUND

Selective laser melting (SLM) and selective laser sintering (SLS) apparatus produce parts through layer-by-layer solidification of a material, such as a metal powder material, using a high energy beam, such as a laser beam. A powder layer is formed across a powder bed in a build chamber by depositing a heap of powder adjacent to the powder bed and spreading the heap of powder with a wiper across (from one side to another side of) the powder bed to form the layer. A laser beam, introduced through a window in the top of the build chamber, is then scanned across areas of the powder layer that correspond to a cross-section of the part being constructed. The laser beam melts or sinters the powder to form a solidified layer. After selective solidification of a layer, the powder bed is lowered by a thickness of the newly solidified layer and a further layer of powder is spread over the surface and solidified, as required. An example of such a device is disclosed in U.S. Pat. No. 6,042,774.

The solidification process is carried out in an inert gas atmosphere, such as an argon or nitrogen atmosphere, as the metal powder is highly reactive. Melting of the powder results in gas-borne particles in the build chamber. These particles include a cloud or fog of nanometre sized particulates formed by material that has re-solidified in the inert atmosphere after being vaporised by the laser. It is undesirable for the gas-borne particles to resettle on the powder bed as this can affect the accuracy of the build. To remove such matter a gas knife of inert gas is generated across the powder bed between a nozzle and an exhaust. The gas collected by the exhaust is passed through a filter to remove the gas-borne particles, the filtered gas recirculated through a gas circuit back to the nozzle.

WO2010/007394 discloses a parallel filter arrangement in which the gas flow through the circuit can be switched between either one of two filter assemblies such that the filter element in the other filter assembly can be replaced during a build.

During a build, the gas-borne particulates can collect on surfaces of the build chamber, including the window, forming a soot-like covering. The particulates collected on the window and the gas-borne particulates can deflect and/or disperse the laser beam, resulting in an inaccurate build. It is known to provide a gas curtain across the window to mitigate the problem of particulates gathering on the window. Examples of such gas flow devices are disclosed in EP0785838 and EP1998929.

It has been found, however, that, even with gas flows across the powder bed and the window, sufficient particulates collect on the window to affect the quality of the build.

US2013/0101803A1 discloses the gas of a construction-chamber atmosphere removed by suction and conducted through a tubular component with cooled areas on which the vapours produced during a layer-by-layer production process can condense. The gas is then conducted back into the construction chamber. The gas of the construction-chamber atmosphere is reheated after condensation of the volatile constituents of the polymer before being conducted back into the construction chamber.

US2014/0265045 discloses a scrubber to clean and filter air within a build chamber of a laser sintering system. The scrubber comprises an initial cooling section. The cooling section is a serpentine passage that causes relatively hot air in the build chamber to be cooled, such as with a heat sink or fan assembly in thermal communication with the passages in the cooling section.

### SUMMARY OF INVENTION

According to a first aspect of the invention there is provided an additive manufacturing apparatus for building a part by selectively consolidating flowable material in a layer-by-layer building process comprising an inert gas vessel comprising a build chamber, a layering device for depositing layers of material in the build chamber; a scanner for delivering an energy beam to selected areas of each layer to consolidate flowable material of the layer; and a thermal device configured to affect heating and/or cooling of an internal surface of the inert gas vessel to cause particulates to be preferentially deposited at a predetermined location in the vessel desirable for particulate collection as a result of a cooler temperature of the predetermined location, the cooler temperature being lower than an ambient temperature of the inert gas.

It has been found that particulates, in particular, nanoparticles created by cooling of the plasma formed during the consolidation process, present in the inert gas deposit on surfaces that are cooler relative to the ambient inert gas temperature. It is believed that by controlling a temperature of an internal surface/temperatures of internal surfaces it is possible to cause the particulates to preferentially deposit onto surfaces at desired locations in the vessel. In this way, the deposition of particulates at undesired locations in the vessel, such as on a laser window, a viewing window, a gas nozzle for delivering gas into the build chamber, a wiper and a doser for delivering powder, may be reduced.

The thermal device may comprise an (active) cooling device for cooling the internal surface. The cooling device may comprise a Peltier device, a heat exchanger through which coolant is pumped, a refrigeration unit and/or other suitable device for cooling a surface.

The cooling device may be arranged to cool an internal surface of the build chamber. The apparatus may comprise a laser for generating a laser beam and the build chamber may comprise a window through which the laser beam is directed by the scanner, wherein the cooling device is arranged to cool an internal surface of the build chamber that is remote from the window.

The cooling device may be arranged to cool a surface of a collection member movable in the vessel relative to a wiper for wiping particulates off the collection member into a collection bin. For example, the collection member may be an annular member mounted for rotation such that the collection member is continuously moved past a wiper, such as a brush, for wiping particulates collected on the annular member into a collection bin. Alternatively, the collection member may be a surface of the build chamber, a wiper being moved across the surface to wipe the particulates into the collection bin. In this way, the surface for the collection of particulates is regularly renewed for efficient particulate collection.

The inert gas vessel may comprise a gas flow circuit for generating an inert gas flow through the build chamber and the cooling device may be arranged to cool an internal surface of the gas flow circuit. The gas flow circuit may comprise a filter for filtering particles from the gas flow and the cooling device may cool an internal surface located upstream of the filter. The cooling device may be arranged to cool an internal surface of the build chamber located in the vicinity of a gas outlet of the gas circuit from the build chamber. The cooling device may comprise a Peltier device, a heat pipe and/or other suitable device for cooling a surface.

The gas circuit may comprise a heater located downstream for heating the cooled inert gas that has passed through the filter before reintroduction of the inert gas onto the build chamber. Alternatively, cooled inert gas may be reintroduced to the build chamber to maintain an ambient temperature of the inert gas below a temperature of internal surfaces of the build chamber.

The thermal device may comprise a heater for heating the internal surface above an ambient temperature of the inert gas. Heating of the internal surface above the ambient temperature may cause particulates to be deposited at a location in the inert gas vessel away from the heated internal surface. The heater may comprise a Peltier device, a radiant heater, a heating element, a heat pipe and/or other suitable device for heating a surface.

The apparatus may comprise a laser for generating a laser beam and the build chamber may comprise a window through which the laser beam is directed by the scanner, wherein the internal surface heated by the heater is a surface surrounding the window. The inert gas vessel may comprise a gas flow circuit for generating an inert gas flow through the build chamber and the internal surface heated by the heater may be a nozzle of the gas circuit for directing the gas flow into the build chamber. The build chamber may comprise a door comprising a viewing window and the internal surface heated by the heater may be an internal surface surrounding the viewing window.

The thermal device may comprise thermally insulative and/or conductive material for affecting the conduction of heat through walls of the inert gas vessel such that particulates preferentially deposit at the predetermined location. During additive manufacturing processes, such as selective laser melting and selective laser sintering, the temperature within the inert gas vessel is higher than that of the external environment such that heat is typically conducted to the external environment through the walls of the vessel. By appropriately arranging insulative and/or highly conductive material in and/or around the inert gas vessel, it may be possible to produce a temperature difference between different locations in the vessel such that particulates preferentially deposit at desired locations in the vessel. For example, thermally insulative material may be provided around a laser window and/or viewing window. A retainer for holding the laser window and/or viewing window in place in the build chamber may be made of insulative material. A gas circuit may comprise conductive material such that internal surfaces of the gas circuit are cooler than other internal surfaces of the inert gas vessel.

According to a second aspect of the invention there is provided a method of removing particulates from an inert gas atmosphere provided in a vessel in a layer-by layer additive manufacturing process, wherein a part is built by selectively consolidating flowable material in layers, the method comprising providing a relatively cool internal surface in the inert gas vessel having a temperature lower than an ambient temperature of the inert gas to cause particulates in the inert gas atmosphere to preferentially deposit on to the internal surface, the internal surface located at a desirable location in the vessel for particulate collection.

The particulates preferential deposit on the internal surface because the internal surface is cooler than other internal surfaces of the vessel.

### DESCRIPTION OF THE DRAWINGS

FIG. 1 is a schematic diagram of an additive manufacturing apparatus according to one embodiment of the invention;

FIG. 2 is a schematic diagram of the additive manufacturing apparatus from another side;

FIG. 3 is a schematic diagram of an additive manufacturing apparatus according to another embodiment of the invention;

FIG. 4 is a schematic diagram of a particulate collection device for use in an additive manufacturing apparatus; and

FIG. 5 is a schematic diagram of an additive manufacturing apparatus according to another embodiment of the invention.

### DESCRIPTION OF EMBODIMENTS

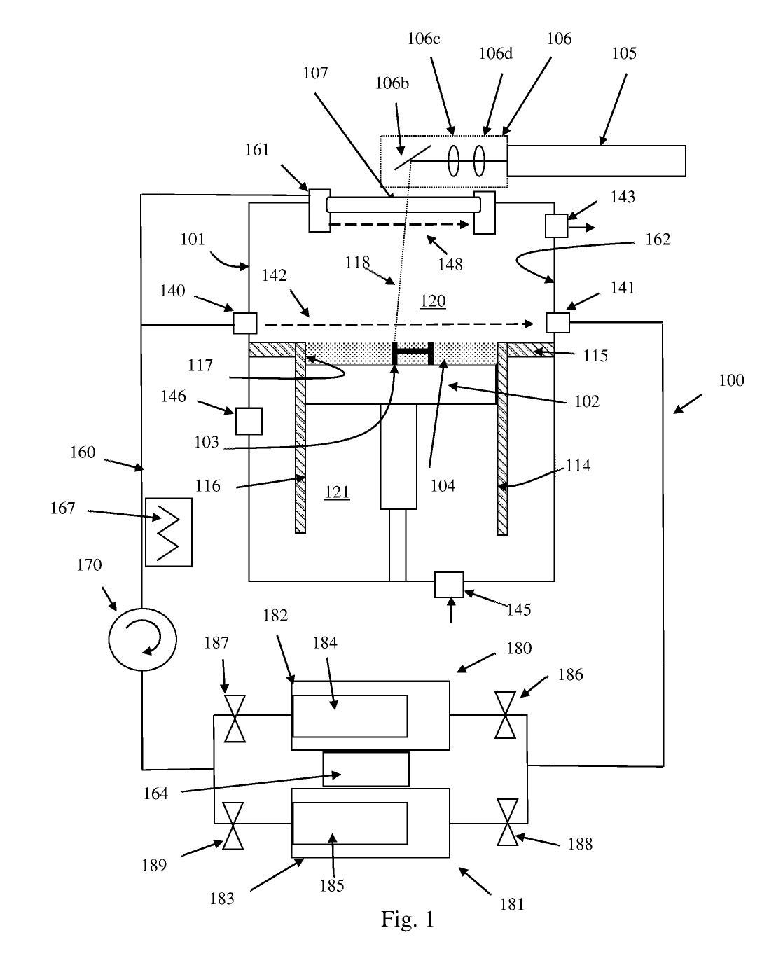

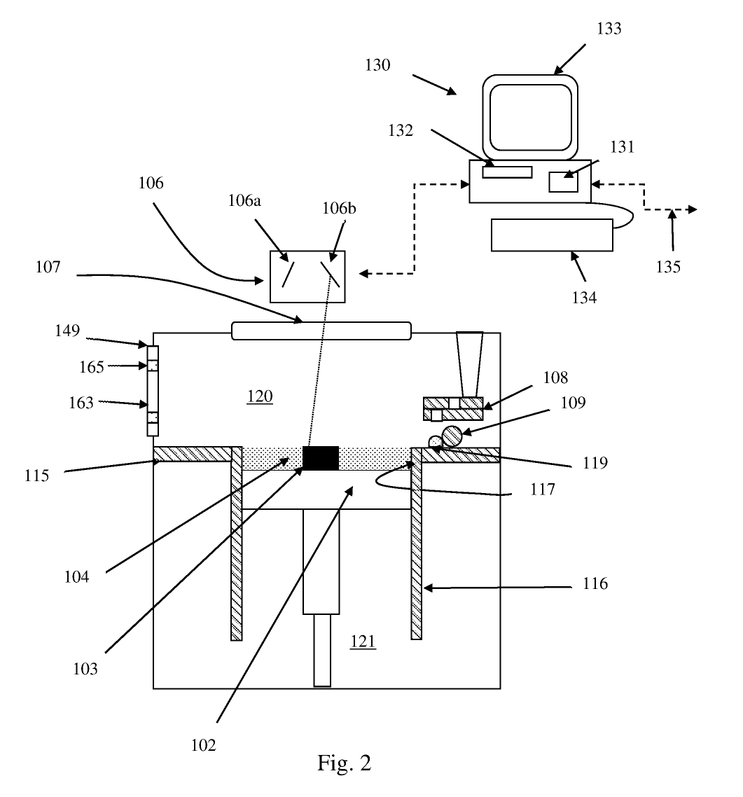

Referring to FIGS. 1 and 2, an additive manufacturing apparatus according to an embodiment of the invention comprises an inert gas vessel 100 comprising build chamber 101 and a gas circuit 160.

The build chamber 101 has partitions 115, 116 therein that define a build cylinder 117 and a surface onto which powder can be deposited. A build platform 102 is provided for supporting a part 103 built by selective laser melting powder 104. The platform 102 can be lowered within the build cylinder 117 as successive layers of the part 103 are formed. A build volume available is defined by the extent to which the build platform 102 can be lowered into the build cylinder 117. The build cylinder 117 and build platform 102 may have any suitable cross-sectional shape, such as circular, rectangular and square.

Partitions 115, 116 and the build platform 102 split the build chamber 101 into an upper chamber 120 and a lower chamber 121. Seals (not shown) around the build platform 102 prevent powder from entering into the lower chamber 121. A gas connection, such as a one-way valve, may be provided between the upper and lower chambers 120, 121 to allow gas to flow from the lower chamber 121 to the upper chamber 120. The lower chamber 121 may be kept at a slight over-pressure relative to the upper chamber 120.

Layers of powder 104 are formed as the part 103 is built by dispensing apparatus 108 and an elongate wiper 109. For example, the dispensing apparatus 108 may be apparatus as described in WO2010/007396.

A laser module 105 generates a laser for melting the powder 104, the laser directed as required by optical scanner 106 under the control of a computer 130. The laser enters the chamber 101 via a window 107.

The optical scanner 106 comprises steering optics, in this embodiment, two movable mirrors 106a, 106b for directing the laser beam to the desired location on the powder bed 104 and focussing optics, in this embodiment a pair of movable lenses 106c, 106d, for adjusting a focal length of the laser beam. Motors (not shown) drive movement of the mirrors 106a and lenses 106b, 106c, the motors controlled by processor 131.

A computer 130 controls modules of the additive manufacturing apparatus, including the thermal devices such as the cooling devices and heaters, as described below . . . Computer 130 comprises the processor unit 131, memory 132, display 133, user input device 134, such as a keyboard, touch screen, etc., a data connection to the modules. Stored on memory 132 is a computer program that instructs the processing unit to carry out the method as now described.

The gas circuit 160 comprises a gas nozzle 140 and a gas exhaust 141 for generating a gas flow 142 through the chamber 101 across the build platform 102. The gas flow 142 acts as a gas knife carrying gas-borne particles created by the melting of the powder with the laser away from the build area. The gas circuit comprises a further gas nozzle integrated into a retainer ring 161 for generating a gas flow 148 across the laser window 107. This gas flow may help to prevent particulates from collecting on the laser window 107, which in turn could affect the quality of the laser beam 118 delivered through the laser window 107.

A pump 170 drives the circulation of inert gas through gas circuit 160.

A vent 143 provides a means for venting/removing gas from the chambers 120, 121. A backfill inlet 145 provides an inlet for backfilling the chambers 120, 121 with inert gas. The lower chamber 121 may comprise a further inlet 146 for maintaining the lower chamber 121 at an overpressure relative to the upper chamber 120.

The gas flow circuit comprises filter assemblies 180, 181 connected in parallel within the gas circuit to filter particulates within the recirculated gas. Each filter assembly 180, 181 comprises a filter housing 182, 183, a filter element 184, 185 located in the filter housing 182, 183 and manually operated valves 186, 187, 188, 189 for opening and closing gas inlet and gas outlet, respectively. Each filter assembly 180, 182 is detachable from the gas circuit for replacement of the filter element 182, 183, as is described in WO2010/026396.

The apparatus comprises thermal devices for affecting the heating and/or cooling of an internal surface of the inert gas vessel 100 to cause particulates to be preferentially deposited at a predetermined location in the vessel 100 desirable for particulate collection.

A first thermal device is a polymer retainer ring 161 for retaining the laser window 107 in place. The polymer material insulates the internal surface of the ring from the colder environment surrounding the build chamber 101. Other internal surfaces of the build chamber 101 are provided with a good thermal coupling to the surrounding environment. For example, walls 162 of the build chamber 101 may be made of material that has good thermal conductivity, such as a metal. Accordingly, during a build, the internal surfaces of the build chamber walls 162 may be cooler than the internal surfaces of the retainer ring 161 and laser window 107 such that particulates preferentially collect on surfaces of the build chamber walls 162 rather than the retainer ring or laser window 107.

Further thermal devices in the form of insulation 165 may also be provided around the inlet nozzle for inert gas and the viewing window 163 in the door 149 to ensure that internal surfaces of the inlet nozzle and viewing window 163 remain at a higher temperature than other internal surfaces of the vessel 100 such that the particulates preferentially deposit on the other internal surfaces.

The gas flow circuit further comprises a thermal device for controlling the temperature of internal surfaces of the gas circuit. In FIGS. 1 and 2, the thermal device is a cooling device 164 for cooling the filter housings 182, 183. The cooling device 164 is arranged to cool internal surfaces of each housing 182, 183 that are exposed to gas flow that has yet to pass through the filter elements 184, 185. The colder internal surface of the filter housings 182, 183 encourage particulates in this gas flow to be deposited on the internal surfaces of the housings 182, 183. The housings 182, 183 may comprise web like structures (not shown) to provide an increased surface area for the collection of particulates.

The cooling device 164 may be a refrigeration unit for cooling a coolant, which in turn flows through heat exchange conduits to cool the housings 182, 183.

Flooding of the housings 182, 183 with water during changing of the filter element cleans particulates from the internal surfaces of the housing 182, 183. As a result, the internal surfaces of the filter housing 182, 183 are desirable locations in vessel 100 for the deposition of particulates.

The gas circuit may further comprise a heater 167 for heating gas downstream of the filter elements such that the inert gas delivered into the build chamber 101 is close to or above the ambient temperature of the inert gas in the build chamber 101. This may help to prevent the build-up of deposits around the inlet nozzle.

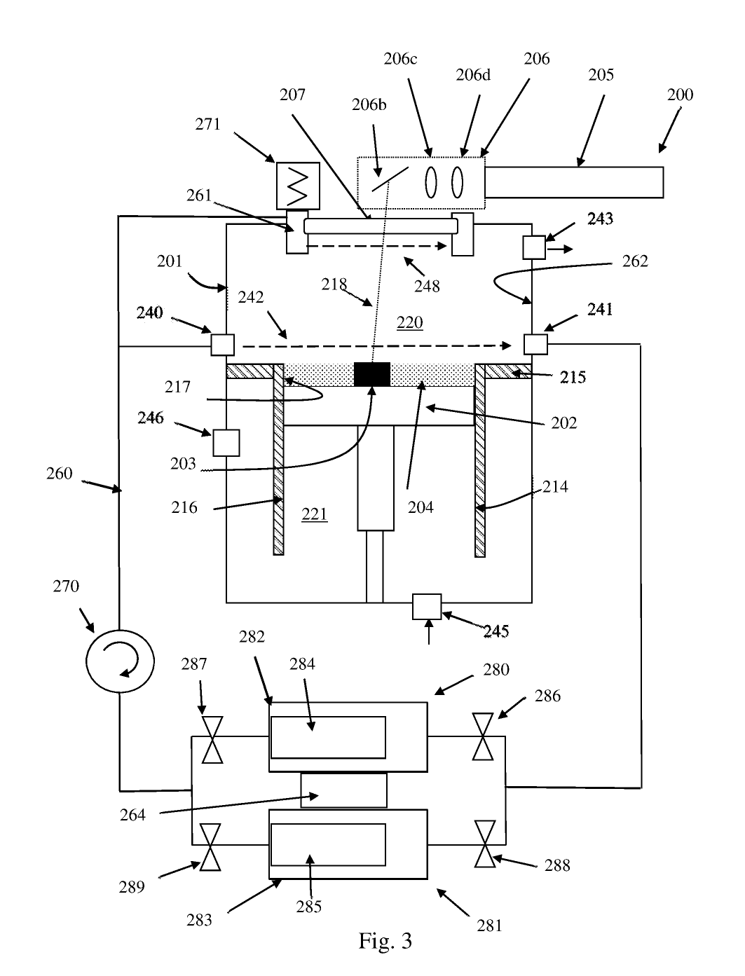

FIG. 3 shows apparatus according to another embodiment of the invention. Features of this embodiment that are the same or similar to features of the embodiment described with reference to FIGS. 1 and 2 have been given the same reference numerals but in the series 200.

The embodiment shown in FIG. 3 differs from that shown in FIGS. 1 and 2 in that the retainer ring 261 is a metal retainer ring thermally coupled to a heater 271. The heater 271 heats the retainer ring 261 such that an internal surface of the retainer ring 261 exposed to the inert gas in the vessel 200 is heated to a temperature above the ambient temperature of the inert gas. Heating of the retainer ring 261 may limit or prevent altogether particulates being deposited on the retainer ring 261 and the laser window 207.

FIG. 3 also differs from the embodiment shown in FIGS. 1 and 2 in that the heater 167 is omitted, such that cooled inert gas is delivered into the build chamber 201.

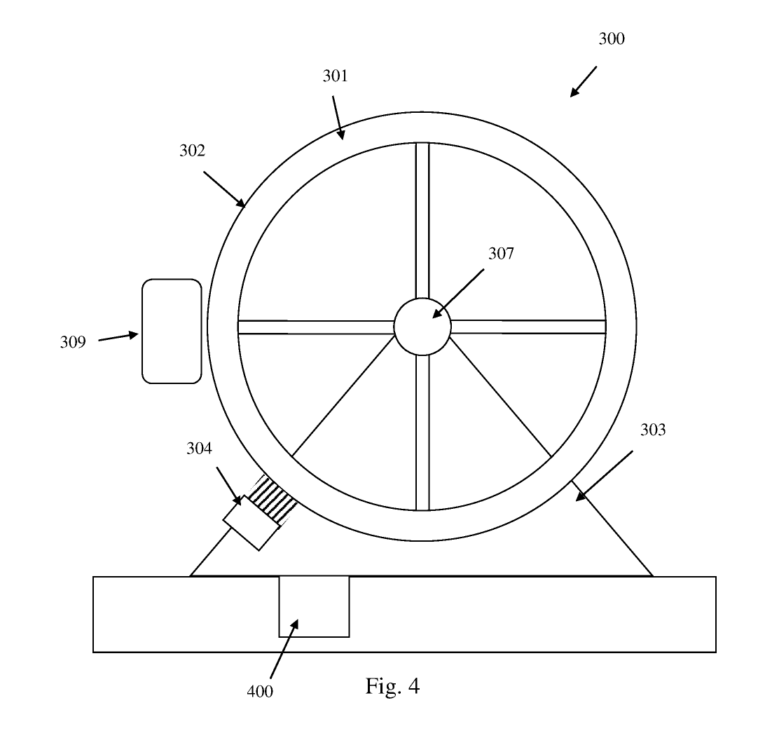

FIG. 4 shows a particulate collection device 300 that may be located in the build chamber shown in FIGS. 1 to 3. The device 300 comprises an elongate annular member 301 having an outer surface 302 for the collection of particulates. The annular member 301 is mounted to a spindle 307 which is itself mounted on a frame 303 to allow rotation of the member 301. The spindle 307 has a formation (not shown) for connecting the spindle to a motor (not shown) for driving rotation of the member 301. A wiper, in this embodiment a brush 304, is mounted on the frame 303 so as to engage the outer surface 302 of the member 301 as the member 301 is rotated. The brush 304 extends along the length of the elongate member 301. The brush 304 removes particulates from the outer surface 302 of the member 301 as the member is rotated. A cooling device 309 is provided to cool the annular member 301 to below an ambient temperature of inert gas in a build chamber of an additive manufacturing apparatus, such as those shown in FIGS. 1 to 3.

In use, the device may be placed in the build chamber, such as close to an exhaust outlet for inert gas and above a collection bin 400 for particulates. During a build, the annular member 301 is cooled and rotated such that particulates in the inert atmosphere preferentially deposit on the surface 302 of the annular member 301. The brush 304 removes the particulates from the annular member 301 causing the particulates to collect in the collection bin 400 located below the device.

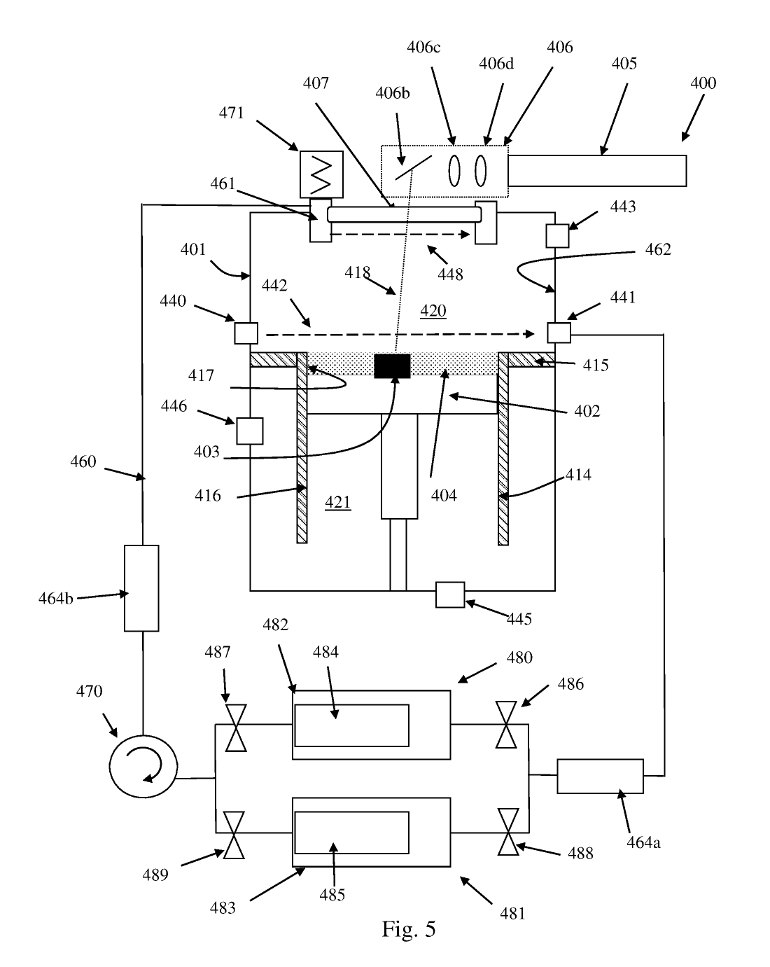

FIG. 5 shows a further embodiment of the invention. Features of this embodiment that are the same or similar to features of the embodiments described with reference to FIGS. 1 to 3 have been given the same reference numerals but in the series 400. This embodiment differs from the embodiments shown in FIGS. 1 to 3 in that two the cooling devices 464a, 464b, one 464a for cooling and capturing particles before the inert gas enters into the filter assemblies 482, 483 and a second downstream of the pump 470 for cooling gas heated by the pump 470. The cooling devices 464a, 464b defines at least one serpentine passageway for the gas, the walls of the passageway(s) cooled by appropriate means, for example a coolant. Internal surfaces of the passageway may comprise spikes or rods that act as cold fingers or anticontaminators (similar to the devices used in electron microscopy) filled with a coolant. Like the embodiment shown in FIG. 3, there is no active heater for heating gas that passes through the gas recirculation loop.

Furthermore, the pump 470 is provided upstream of the cooling device 464. This may be advantageous as the specifications for the pump 470 are not limited by the need to pass cooled gas therethrough.

In use of any of the above described embodiments, the inert gas may be cooled and passed into the build chamber 101, 201, 401 without being heated by a heater, to cool the gas within the chamber 101 to a temperature below that of internal surfaces of the build chamber 101, 201, 401. (In the first embodiment, the computer 130 may deactivate the heater 167 such that the cooled inert gas passes into the build chamber 101). This may reduce a capacity of the inert gas in the build chamber 101, 201, 401 to hold vaporised material, such a vaporised metal material, produced during the additive building process. Accordingly, less vaporised material will migrate to critical surfaces, such as window 107, 207, 407, which are desirably maintained free of condensate. Furthermore, the metal vapour held within the gas is less likely to condense onto the internal surfaces of the build chamber because the surfaces are at a higher temperature (as the walls of the build chamber are in thermal communication with the external environment which is at a higher temperature) than the temperature of the inert gas. In particular, heater 271, 471 may be used to heat the retainer ring 261, 461 around the window 207, 407 to elevate a temperature of an internal surface of the window 207, 407 above a temperature of the inert gas in the build chamber 201, 401. The cooled gas 142, 242, 442 acts as a cooled gas blanket/curtain thermally isolating critical surfaces, such as the window 107, 207, 407 and viewing window 163 of door 165 from the heated powder bed 104, 204, 404 and solidified material of the object 103, 203, 204.

The gas flows 142, 242, 442 may generate a temperature inversion layer within the build chamber 101, 201, 401 wherein a layer of warmer gas is trapped above the gas flow 142, 242, 442 of the cooled gas. The temperature inversion may act to trap vaporised material below the layer of warm gas where the particulates are removed by the gas knife 142, 242, 442.

The cooled inert gas delivered into the build chamber may be less than 20 degrees and preferably between 0 and 10 degrees.

Furthermore, at the end of the build, cooled inert gas continues to be recirculated/is recirculated to cool the build chamber 101, 201, 401 and the object built using the additive build process. This may reduce the time between the end of the build and when the build chamber and object have cooled sufficiently to allow the build chamber door to be opened and the object removed from the build chamber 101, 201, 401.

It will be understood that alterations and modifications may be made to the embodiments as described herein without departing from the invention as defined in the claims.

1. An additive manufacturing apparatus for building a part by selectively consolidating flowable material in a layer-by-layer building process comprising an inert gas vessel comprising a build chamber, a layering device for depositing layers of material in the build chamber; a scanner for delivering an energy beam to selected areas of each layer to consolidate flowable material of the layer, a gas flow circuit for generating an inert gas flow through the build chamber and a cooling device arranged to cool an internal surface of the gas flow circuit to generate cooled inert gas, wherein the gas flow circuit is arranged such that the cooled inert gas can be delivered into the build chamber.

2. An additive manufacturing apparatus according to claim 1, wherein the gas flow circuit is arranged such that the cooled inert gas can be delivered into the build chamber to maintain an ambient temperature of the inert gas in the build chamber below a temperature of internal surfaces of the build chamber.

3. An additive manufacturing apparatus according to claim 1, wherein the cooled inert gas delivered into the build chamber has not been heated by a heater after being cooled by the cooling device.

4. An additive manufacturing apparatus according to claim 1, wherein the gas flow circuit does not comprise a heater for heating the cooled inert gas.

5. An additive manufacturing apparatus according to claim 1, wherein the gas flow circuit comprises a heater for heating the cooled inert gas before reintroduction of the inert gas onto the build chamber, the apparatus further comprising a controller for controlling the heater to regulate heating of the cooled inert gas by the heater such that, in one mode of operation, the cooled inert gas can be delivered into the build chamber.

6. An additive manufacturing apparatus according to claim 5, wherein the controller is arranged to deactivate the heater such that the cooled inert gas is delivered into the build chamber.

7. An additive manufacturing apparatus according to claim 1, wherein the gas flow circuit is arranged to generate a gas curtain of the cooled inert gas across the build chamber to reduce heat transfer between two volumes of the build chamber separated by the build curtain.

8. An additive manufacturing apparatus according to claim 7, comprising a laser for generating a laser beam and the build chamber comprises a window through which the laser beam is directed by the scanner, wherein the gas flow circuit is arranged to generate the gas curtain across the build chamber between the window and the layers of material deposited in the build chamber.

9. An additive manufacturing apparatus according to claim 1, wherein the cooling device is configured to affect cooling of the internal surface of the gas flow circuit to cause particulates to be preferentially deposited at a predetermined location in the gas flow circuit desirable for particulate collection as a result of a cooler temperature of the predetermined location, the cooler temperature being lower than an ambient temperature of the inert gas.

10. An additive manufacturing apparatus according to claim 1, wherein the cooling device comprises a Peltier device, a heat exchanger through which coolant is pumped and/or a refrigeration unit.

11. An additive manufacturing apparatus according to claim 1, wherein the gas flow circuit comprises a filter for filtering particles from the gas flow and the cooling device is arranged to cool an internal surface located upstream of the filter.

12. An additive manufacturing apparatus according to claim 1, wherein the thermal device comprises a heater for heating an internal surface of the build chamber above an ambient temperature of the inert gas in the build chamber.

13. An additive manufacturing apparatus according to claim 12, wherein the heater comprises a Peltier device, a radiant heater and/or an electrical resistive heating element.

14. An additive manufacturing apparatus according to claim 12, comprising a laser for generating a laser beam and the build chamber comprises a window through which the laser beam is directed by the scanner, wherein the internal surface heated by the heater is a surface surrounding the window.

15. An additive manufacturing apparatus according to claim 12, wherein the internal surface heated by the heater is a nozzle of the gas circuit for directing the gas flow into the build chamber.

16. An additive manufacturing apparatus according to claim 12, wherein the build chamber comprises a door comprising a viewing window and the internal surface heated by the heater is an internal surface surrounding the viewing window.

17. An additive manufacturing apparatus according to claim 1, wherein a temperature of the cooled inert gas delivered into the build chamber is greater than 30 degrees centigrade below a temperature of gas in the build chamber.
